(19) United States
(12) Patent Application Publication
(10) Pub. No.: US 2026/0111974 A1
(43) Pub. Date: Apr. 23, 2026

(54) Machine Learning Based Overbooking Limit Optimization

(71) Applicant: Oracle International Corporation, Redwood Shores, CA (US)

(72) Inventors: Andrew VAKHUTINSKY, Sharon, MA (US); Farbod EKBATANI, Chicago, IL (US); Jason G BRYANT, Las Vegas, NV (US); Kirby BOSCH, Ann Arbor, MI (US); Zuxuan HUAI, New York, NY (US); Boro PETROVIC, Naples, FL (US); Jorge Luis Rivero PEREZ, Naples, FL (US); Natalia KOSILOVA, Burlington, MA (US)

(73) Assignee: Oracle International Corporation, Redwood Shores, CA (US)

(21) Appl. No.: 19/079,626

(22) Filed: Mar. 14, 2025

Related U.S. Application Data
(60) Provisional application No. 63/710,725, filed on Oct. 23, 2024.

(51) Int. Cl. G06Q 50/12; G06Q 10/02

(52) U.S. Cl. CPC G06Q 50/12; G06Q 10/02

(57) ABSTRACT

Embodiments optimize hotel room overbooking limits for reservations of hotel rooms of a hotel. Embodiments receive historical reservation data and determine an upgrade offer acceptance probability as a function offer price based on the historical reservation data. Embodiments determine a premium category occupancy distribution based on the historical reservation data and determine a basic category cancellation distribution based on the historical reservation data. Embodiments determine an optimal upgrade price as a function of overbooked rooms from the upgrade offer acceptance probability and determine a marginal revenue as a function of overbooked rooms based on the determined premium category occupancy distribution and the determined optimal upgrade price as a function of overbooked rooms. Embodiments determine a marginal loss as a function of overbooked rooms from the basic category cancellation distribution.

### CROSS REFERENCE TO RELATED APPLICATIONS

This application claims priority to U.S. Provisional Patent Application Ser. No. 63/710,725, filed on Oct. 23, 2024, the disclosure of which is hereby incorporated by reference.

### FIELD

One embodiment is directed generally to a computer system, and in particular to a computer system implementing machine learning based overbooking limit optimization.

### BACKGROUND INFORMATION

Revenue management is the process of dynamically adjusting prices of goods or services in response to changes in market conditions or changes in supply conditions. Revenue management processes were pioneered by the passenger airline industry and have been imitated by other industries such as cargo airlines, hotels, car rentals, shippers, advertisement brokers and others.

A very common application of revenue management relates to service providers who are taking reservations for “date-constrained services”. Date-constrained services involve the imposition of transaction-specific limits on the date when the buyer may use the services they purchase. Examples of such restrictions include specified arrival and departure dates for an airline reservation as well as specified check-in and check-out dates for a hotel reservation. The time restrictions make it particularly difficult to estimate demand and then determine optimized pricing that maximizes revenue/profit for date-constrained services, especially in the hotel industry.

Hotel revenue management can be viewed as an extension of airline revenue management. While methodologies developed for hotels can often be adapted for airlines, the reverse is not always feasible. A primary distinction is the nature of hotel room bookings, which can span multiple days, allowing for the reuse of rooms. Consequently, room availability varies daily because certain rooms may be occupied by guests staying for extended periods. In contrast, the seat inventory in airlines remains consistent for each flight regardless of the class (e.g., first, business, or economy).

One aspect of revenue management for date-constrained services is the overbooking of inventory, because of cancellations and no-shows, in an attempt to maximize occupancy and revenue.

### SUMMARY

Embodiments optimize hotel room overbooking limits for reservations of hotel rooms of a hotel. Embodiments receive historical reservation data and determine an upgrade offer acceptance probability as a function offer price based on the historical reservation data. Embodiments determine a premium category occupancy distribution based on the historical reservation data and determine a basic category cancellation distribution based on the historical reservation data. Embodiments determine an optimal upgrade price as a function of overbooked rooms from the upgrade offer acceptance probability and determine a marginal revenue as a function of overbooked rooms based on the determined premium category occupancy distribution and the determined optimal upgrade price as a function of overbooked rooms. Embodiments determine a marginal loss as a function of overbooked rooms from the basic category cancellation distribution.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be designed as multiple elements or that multiple elements may be designed as one element. In some embodiments, an element shown as an internal component of another element may be implemented as an external component and vice versa. Furthermore, elements may not be drawn to scale.

FIG. 1 is an overview block diagram of a hotel reservation system in accordance to embodiments of the invention.

FIG. 2 is a block diagram of a computer server/system in accordance with an embodiment of the present invention.

FIG. 3 illustrates premium fare protection in accordance to embodiments.

FIG. 4 illustrates stopping condition in accordance to embodiments.

FIG. 5 is a flow diagram of the functionality of the system of FIG. 2 when optimizing hotel room overbooking for a hotel reservation system in accordance to embodiments.

FIGS. 6A and 6B are graphs that plot the loss and revenue margins as functions of the number of rooms overbooked in accordance to embodiments.

FIGS. 7-10 illustrate an example cloud infrastructure that can implement hotel chain operations that can include the overbooking optimization module of FIG. 2 in accordance to embodiments.

### DETAILED DESCRIPTION

Embodiments set optimal booking limits for hotel reservations made in the standard/basic room category when there exists both standard and premium room categories. Embodiments assume that the premium room category is expected to be booked below capacity, so that the overbooking of the standard room category can utilize the extra space in the premium category.

Further, a hotel may offer the standard room category customers an upgrade to the premium rooms at a discount rate. Therefore, embodiments consider two sets of decision variables, daily overbooking limits for the standard category, and upgrade offer prices, with the objective to optimize the total revenue subject to overall room capacity. By setting the overbooking limits, embodiments result in the optimal tradeoff between selling some premium rooms at the standard room rate and keeping other premium rooms aside for the potential future sales at the premium rate (also referred to as “fare protection”).

Further, embodiments account for multi-day reservations by deciding on every multi-day reservation whether to allow its booking based on the current booking level, therefore exercising “admission control.” Embodiments further adjust the booking limits by accounting for the predicted booking cancellations.

Reference will now be made in detail to the embodiments of the present disclosure, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, and circuits have not been described in detail so as not to unnecessarily obscure aspects of the embodiments. Wherever possible, like reference numbers will be used for like elements.

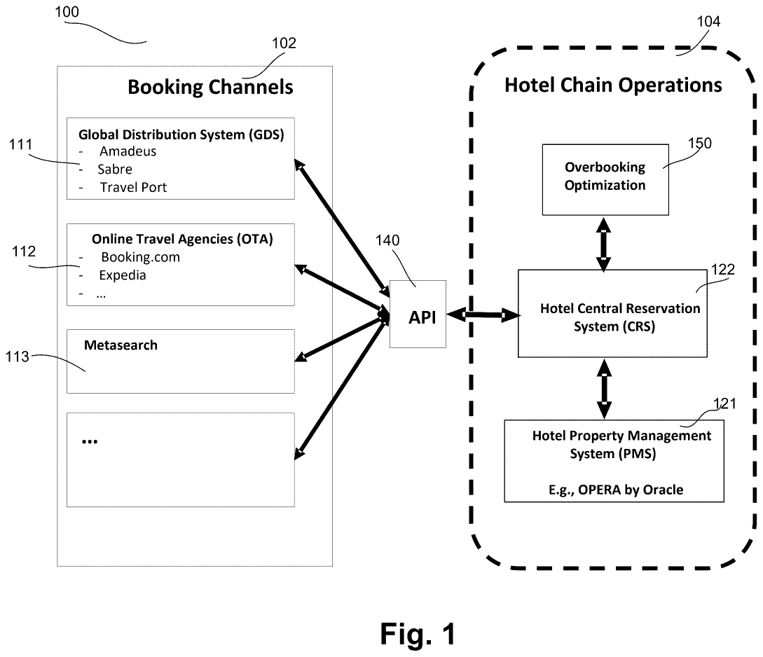

FIG. 1 is an overview block diagram of a hotel reservation system 100 in accordance to embodiments of the invention. FIG. 1 includes booking channels 102 that a potential hotel customer may interact with to reserve a hotel room. The channels include a Global Distribution System (“GDS”) 111, including “Amadeus”, “Sabre”, “Travel Port”, etc., Online Travel Agencies (“OTA”) 112, including “Booking.com”, “Expedia”, etc., Metasearch sites 113, and any other means for a customer to reserve a hotel room, including a website maintained by a hotel chain or individual hotel.

Each hotel chain operations 104 is accessed by an Application Programming Interface (“API”) 140 as a Web Service such as a “WebLogic Server” from Oracle Corp. Hotel chain operations 104 includes a Hotel Property Management System (“PMS”) 121, such as “OPERA Cloud Property Management” from Oracle Corp., a Hotel Central Reservation System (“CRS”) 122, and an overbooking optimization module 150 that interfaces with systems 121 and 122 to provide overbooking optimization, and all other functionality disclosed herein. In embodiments, hotel chain operations 104 is implemented by a cloud based infrastructure. In one embodiment, the cloud based infrastructure comprises the “Oracle Cloud Infrastructure” (“OCI”) from Oracle Corp.

A hotel customer or potential hotel customer that uses system 100 to obtain a hotel room typically engages in a three stage booking process. First an area availability search is conducted. Multiple hotel chains are shown and hotel CRS 122 provides static data. The static data can include the min/max rate, available dates, etc.

If the booking customer selects a hotel, they go to the next step which is the property search, including a single hotel property, multiple rooms and rate plans. For the single hotel property, information may include room category description data, rate plan description and room price, each of which is shown in a specific order. The property search includes real-time availability data and results in the booking customer selecting a room. Once the room is selected, the final step is final booking and the reservation being guaranteed by a credit card or other form of payment.

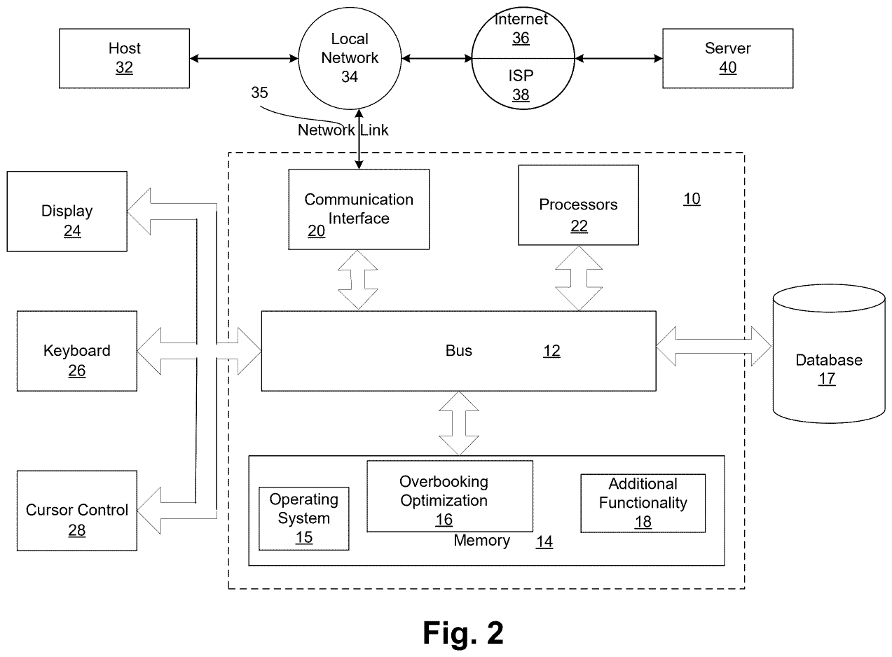

FIG. 2 is a block diagram of a computer server/system 10 in accordance with an embodiment of the present invention. Although shown as a single system, the functionality of system 10 can be implemented as a distributed system. Further, the functionality disclosed herein can be implemented on separate servers or devices that may be coupled together over a network. Further, one or more components of system 10 may not be included. For example, when implemented as a web server or cloud based functionality, system 10 is implemented as one or more servers, and user interfaces such as displays, mouse, etc. are not needed. In embodiments, system 10 can be used to implement any of the elements shown in FIG. 1.

System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as a network interface card, to provide access to a network. Therefore, a user may interface with system 10 directly, or remotely through a network, or any other method.

Computer readable media may be any available media that can be accessed by processor 22 and includes both volatile and nonvolatile media, removable and non-removable media, and communication media. Communication media may include computer readable instructions, data structures, program modules, or other data in a modulated data signal such as a carrier wave or other transport mechanism, and includes any information delivery media.

Processor 22 is further coupled via bus 12 to a display 24, such as a Liquid Crystal Display (“LCD”). A keyboard 26 and a cursor control device 28, such as a computer mouse, are further coupled to bus 12 to enable a user to interface with system 10.

In one embodiment, memory 14 stores software modules that provide functionality when executed by processor 22. The modules include an operating system 15 that provides operating system functionality for system 10. The modules further include overbooking optimization module 16 that models overbooking to provide overbooking limits during the reservation process, as well as additional functionality disclosed herein. System 10 can be part of a larger system. Therefore, system 10 can include one or more additional functional modules 18 to include the additional functionality, such as the functionality of a Property Management System (“PMS”) (e.g., the “Oracle Hospitality OPERA Property” or the “Oracle Hospitality OPERA Cloud Services”) or an enterprise resource planning (“ERP”) system. A database 17 is coupled to bus 12 to provide centralized storage for modules 16 and 18 and store guest data, hotel data, transactional data, etc. In one embodiment, database 17 is a relational database management system (“RDBMS”) that can use Structured Query Language (“SQL”) to manage the stored data.

In embodiments, communication interface 20 provides a two-way data communication coupling to a network link 35 that is connected to a local network 34. For example, communication interface 20 may be an integrated services digital network (“ISDN”) card, cable modem, satellite modem, or a modem to provide a data communication connection to a corresponding type of telephone line or Ethernet. As another example, communication interface 20 may be a local area network (“LAN”) card to provide a data communication connection to a compatible LAN. Wireless links may also be implemented. In any such implementation, communication interface 20 sends and receives electrical, electromagnetic or optical signals that carry digital data streams representing various types of information.

Network link 35 typically provides data communication through one or more networks to other data devices. For example, network link 35 may provide a connection through local network 34 to a host computer 32 or to data equipment operated by an Internet Service Provider (“ISP”) 38. ISP 38 in turn provides data communication services through the Internet 36. Local network 34 and Internet 36 both use electrical, electromagnetic or optical signals that carry digital data streams. The signals through the various networks and the signals on network link 35 and through communication interface 20, which carry the digital data to and from computer system 800, are example forms of transmission media.

System 10 can send messages and receive data, including program code, through the network(s), network link 35 and communication interface 20. In the Internet example, a server 40 might transmit a requested code for an application program through Internet 36, ISP 38, local network 34 and communication interface 20. The received code may be executed by processor 22 as it is received, and/or stored in database 17, or other non-volatile storage for later execution.

In one embodiment, system 10 is a computing/data processing system including an application or collection of distributed applications for enterprise organizations, and may also implement logistics, manufacturing, and inventory management functionality. The applications and computing system 10 may be configured to operate locally or be implemented as a cloud-based networking system, for example in an infrastructure-as-a-service (“IAAS”), platform-as-a-service (“PAAS”), software-as-a-service (“SAAS”) architecture, or other type of computing solution.

As disclosed, embodiments are directed to optimizing hotel booking limits for standard/basic room categories in conjunction with the ability for hotel guests to be offered paid upgrades to premium rooms. For a typical hotel, or hotel chain, the demand for basic room categories may exceed their physical capacity while the demand for premium rooms may be below the capacity. In general, the hotels typically allow excessive bookings in the basic category followed by complimentary upgrades in the premium category, if needed, for the customers initially booking at the basic rate, which may result in revenue loss when the number of free upgrades is too high.

In contrast, embodiments find the optimal overbooking limits in the basic category when the basic category customers are offered a paid upgrade to a premium room. Embodiments balance the marginal return rate of the current basic category at the given booking limit with the expected future sales of the premium category at a certain level, which allows hotel operators to increase the booking limit and at the same time increase their key performance indicators, such as revenue per room. This approach is extended to the case when some customers book multi-day stays and the decision has to be made whether to violate the single-day booking limits to allow the multi-day bookings. Embodiments also account for potential future cancellations.

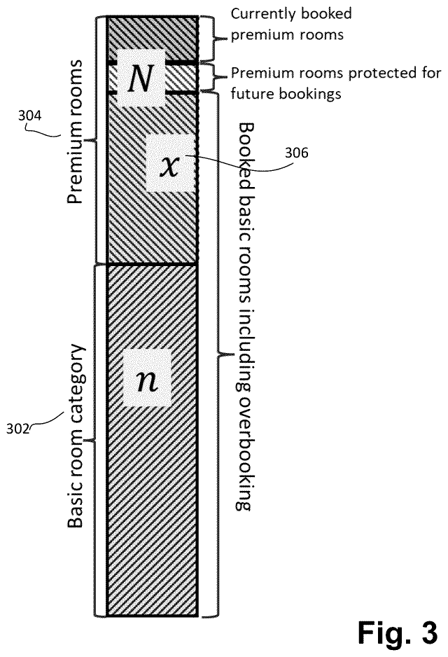

FIG. 3 illustrates premium fare protection in accordance to embodiments. As illustrated in FIG. 3, the following variables are implemented in embodiments:
n: Number of rooms available in the standard/basic room category (302).
N: Number of rooms available in the premium room category (304).
x: Number of basic rooms overbooked into the premium category (306).
r: Revenue from a basic room booking.
R: Revenue from a premium room booking (r<R).
F: Cumulative distribution function (“CDF”) of the occupancy in the premium category.
   Additionally, two random variables are defined:
Y: Number of premium category rooms booked and checked in.
Z: Number of future cancellations for basic category rooms.

### Stopping Condition for Selling Premium Rooms at Basic Room Prices

Overbooking basic rooms by using un-booked premium rooms for any unavailable basic rooms at check-in is equivalent to selling premium rooms at the price of basic rooms. The optimal upper boundary for the sale at discount price x is determined by equating the marginal revenue r and expected marginal loss due to the selling out of the premium rooms when demand reaches the capacity:

$$r = ( Y > Z + N - x ) \cdot R ,$$

where the right-hand-side is based on the probability that demand for premium rooms (Y) booked and checked in exceeds the number of available rooms after accounting for future cancellations (Z) and overbooked standard rooms (x).

Rearranging this equation leads to an expression for the number of overbooked rooms x:

$$x = {F}_{Y - Z}^{- 1} ( 1 - \frac{r}{R} ) .$$

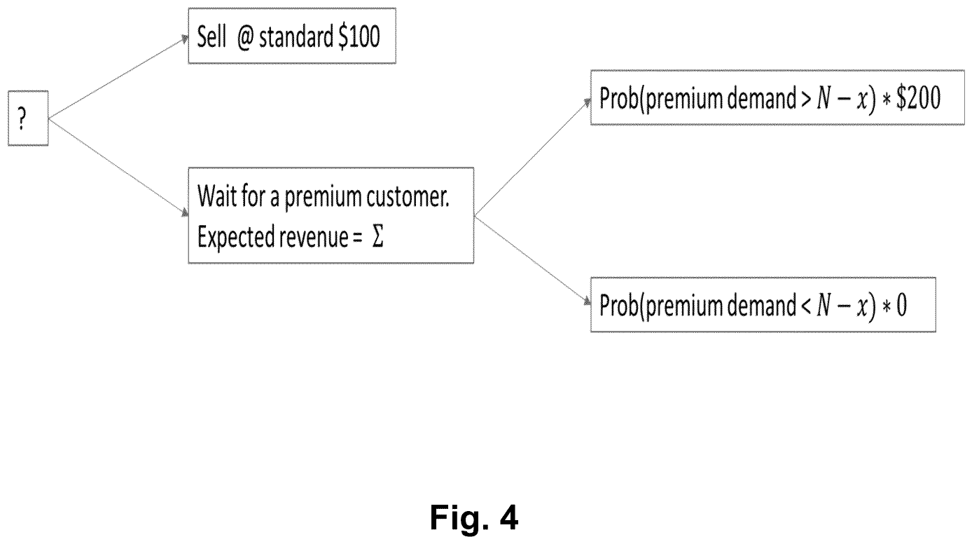

This expression indicates that the number of overbooked standard rooms into premium rooms (x) is determined by the inverse CDF of the net occupancy difference (Y−Z), evaluated at the probability ratio r/R. FIG. 4 illustrates the above stopping condition in accordance to embodiments. In FIG. 4, it is assumed the basic room rate is $100 and the premium room rate is $200.

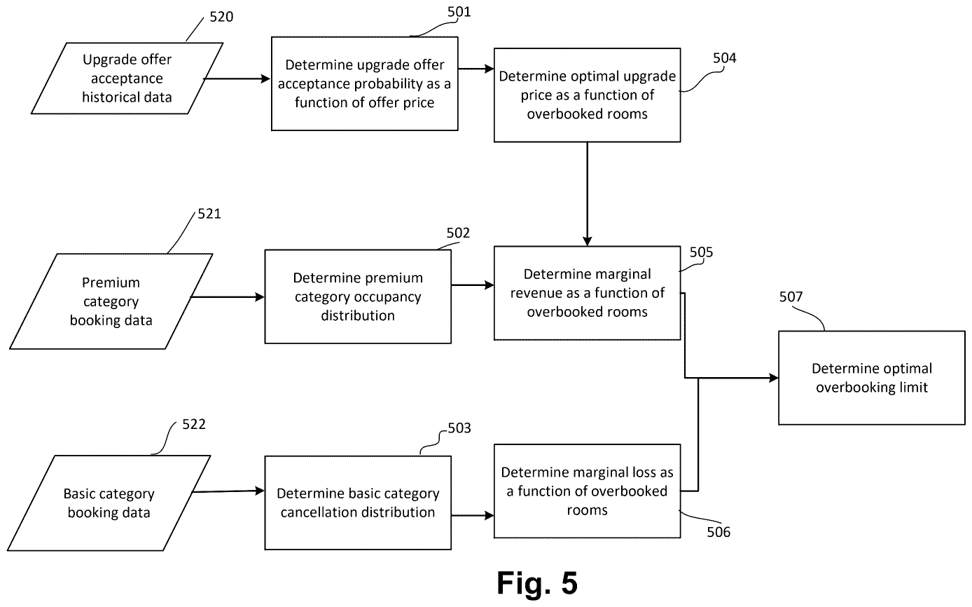

FIG. 5 is a flow diagram of the functionality of system 10 of FIG. 2 when optimizing hotel room overbooking for a hotel reservation system in accordance to embodiments. In one embodiment, the functionality of the flow diagram of FIG. 5 is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software. The functionality of FIG. 5 is disclosed for a hotel reservation system, but in other embodiments can be adapted to any date-constrained environment.

Embodiments receive three different inputs, all from historical booking data: upgrade offer acceptance at 520; premium category booking data at 521; and basic/standard category booking data 522. The historical data 521 and 522 include all cancellation data and is received from a property management system, such as PMS 121 of FIG. 1.

At 501, the upgrade offer acceptance probability as a function of offer price is determined by estimating the parameter of the exponentially decaying acceptance probability model in the following way: The data are given in the two-column format (offer price, is offer accepted? True/False). The acceptance probability function is Prob(p)=e^{-βp} where p is the offer price and β is a parameter estimated using the maximum likelihood-based approach:
For each observation i with offer price pᵢ and outcome yᵢ (1 if accepted, 0 if rejected), the likelihood for all n observations is:

$$L ( β ) = {\prod }_{i = 1}^{n} {( {e}^{- β {p}_{i}} )}^{{y}_{i}} {( 1 - {e}^{- β {p}_{i}} )}^{1 - {y}_{i}}$$

Then the corresponding log-likelihood function is:

$$ℓ ( β ) = {\sum }_{i = 1}^{n} ( - {y}_{i} β {p}_{i} + ( 1 - {y}_{i} ) log ( 1 - {e}^{- β {p}_{i}} ) ) ,$$

which is maximized using a standard software library (e.g., Python's scipy.optimize) to obtain an estimator for β parameter.

At 502, the premium category occupancy distribution and at 503, the basic category cancellation distribution are determined using historical data 521 and 522. In one embodiment, the distributions at 502 and 503 are determined, for example, using functionality disclosed in U.S. patent Ser. No. 18/645,673, entitled “Machine Learning Based Overbooking Limit Optimization”, the disclosure of which is hereby incorporated by reference.

In embodiments, the functionality of 501-503 implement ML algorithms of different kinds. At 501 the ML algorithm fits the historical data to estimate the model parameter and then to compare two alternatives: parametric exponential decay and nonparametric linear models. At 502 and 503, embodiment implements an ML approach to finding the distributions of the premium category occupancy and standard category cancellations as disclosed in U.S. patent Ser. No. 18/645,673.

At 504, embodiments determine an optimal upgrade price as a function of overbooked rooms. Embodiments implement this functionality of determining “paid upgrades” as follows:

```
• r, R = revenues for basic and premium rooms, r < R
• n = number of rooms in the basic category
• x = number of basic category rooms to be overbooked in the premium
    category (decision variable).
        •Total number of basic-price bookings = n + x
• p = upgrade offer price (decision variable) - assumed to be static
• Demand for upgrade =Prob (p)(n + x)
$\cdot Probability of accepting the offer \text{:} Prob ( p ) = \{ \begin{matrix}1 & \begin{matrix}if p = \\ 0 ( free upgrade )\end{matrix} \\ \sim 0 & if p = R - r\end{matrix}$
        • The latter is because otherwise the premium room would be
          initially booked
• Two cases for Prob (p) function:
        $\cdot Linear \text{:} Prob ( p ) = 1 - \frac{p}{R - r}$
        • Exponentially decaying: Prob (p) = e^{-βp} where β is estimated from
          historic observations
```

At 505, embodiments determine a marginal revenue as a function of overbooked rooms. Embodiments implement two models of demand based on acceptance probability models outlined above, linear and log-linear. These two models are compared based on their fit on the test data. At 505 the following functionality determines a room upgrade optimization for linear demand:

```
•Total revenue = OfferPrice*AcceptanceProbability*NumberOfOffers
$\cdot Revenue maximization \text{:} Rev ( p , x ) = p ( 1 - \frac{p}{R - r} ) ( n + x )$
                            ${p}^{*} = arg {max}_{0 \leq p \leq R - r} Rev ( p , x )$
Subject to total demand not exceeding the overbooked premium rooms:
                            $( 1 - \frac{p}{R - r} ) ( n + x ) \leq xx$
$Stock - clearing price ( “ SCP ” ) : {p}_{SCP} = \frac{n}{n + x} ( R - r )$
$Revenue - maximizing price : {p}_{max} = \frac{1}{2} ( R - r )$
        $Optical price : {p}^{*} ( x ) = max ( \frac{n}{n + x} , \frac{1}{2} ) ( R - r ) .$
```

At 504 the following functionality determines a room upgrade optimization for log-linear demand:

```
• Revenue maximization: Rev (p, x) = pe^{-βp} (n + x)
                                            ${p}^{*} = arg {max}_{0 \leq p \leq R - r} R e v ( p , x )$
Subject to total demand not exceeding the overbooked premium rooms:
                                                  e^{-βp} (n + x) ≤ x
$Stock - clearing price ( “ SCP ” ) : {p}_{S C P} = \frac{1}{β} log \frac{n + x}{x}$
$Revenue - maximizing price : {p}_{max} = \frac{1}{β}$
  $Optical price : {p}^{*} ( x ) = \frac{1}{β} max ( log \frac{n + x}{n} , 1 )$
```

At 506, embodiments determine a marginal loss as a function of overbooked rooms. Embodiments implement this functionality as follows for premium fair protection with cancellations:

```
• Previous result: r = Prob (Y > N - x*)R
• Additional input: cancellation of basic rooms
• Z = number of future basic booking cancellations (random variable)
• r = Prob (Y > N - (x* - Z)⁺)R
• The result:
                      ${x}^{*} = N - {F}_{Y - {Z}^{+} ( {x}^{*} )}^{- 1} ( 1 - \frac{r}{R} )$
${Z}^{+} ( {x}^{*} ) = \{ \begin{matrix}Z & if Z \leq {x}^{*} \\ 0 , & otherwise\end{matrix}$
• Not a closed form solution but can still be calculated relatively fast
  as the numberof premium rooms is relatively small
```

At 507, embodiments determine the optimal overbooking limit as follows to determine booking limits with paid upgrade offers:

```
• Optimal booking limit: Marginal revenue equals marginal loss
                                                  r = (1 - F_{Y}(N - x*))R
            - updating the LHS by extra revenue from the upgrades:
                                        $r + \frac{\partial R e v ( {p}^{*} ( x ) , x )}{\partial x} = ( 1 - {F}_{Y} ( N - {x}^{*} ) ) R$
                                          ${x}^{*} = N - {F}_{Y - {Z}^{+} ( {x}^{*} )}^{- 1} ( 1 - \frac{r + \frac{\partial R e v ( x )}{\partial x}}{R} )$
$Linear demand : \frac{\partial R e v ( x )}{\partial x} = \{ \begin{matrix}\frac{{n}^{2}}{{( n + x )}^{2}} ( R - r ) & if x \leq n \\ \frac{1}{4} ( R - r ) , & otherwise\end{matrix}$
$Log - linear demand : \frac{\partial R e v ( x )}{\partial x} = \{ \begin{matrix}\frac{1}{β} ( log \frac{n + x}{x} - \frac{n}{n + x} & if x \leq \frac{n}{e - 1} \\ \frac{1}{β e} , & otherwise\end{matrix}$
In both cases, the marginal revenue at 505 is diminishing ->
concave function
```

The result of the functionality of FIG. 5 is to determine optimal overbooking limits, and in response accept the selections of rooms according to the overbooking limits. Based on the determined overbooking limit, one or more types of rooms are offered in a user interface to be selected by a potential customer, where additional basic rooms beyond the inventory are offered per the determined optimized overbooking limits for basic rooms. In response to selecting/assigning an optimized specific room at check-in, or upgrading to a more premium room in response to the overbooking, embodiments include transmitting specialized data (i.e., data specific to the selected room) to other specialized devices that use the data, such as using the data to automatically encode hotel room keys, using the data to automatically program hotel room door locks, etc.

### Paid Upgrade Offer: Linear and Log-Linear Demand Cases

As disclosed, at 505 embodiments consider the impact (i.e., marginal revenue) of offering paid upgrades. Embodiments consider two models of how the demand for upgrades responds to the price: linear and log-linear demand.

### Linear Demand Case

In the case of linear demand, embodiments assume the following:
If the offered upgrade price exceeds the difference between the premium and standard room prices (R−r), the probability of accepting the upgrade is zero.
If the upgrade is offered for free (p=0), the probability of accepting the upgrade is one.
   Thus, the upgrade probability as a function of the offered price p is:

$$1 - \frac{p}{R - r} .$$

The total revenue from paid upgrades, as a function of the offered price p and the number of overbooked rooms x, is:

$$Rev ( p , x ) = p ( 1 - \frac{p}{R - r} ) ( n + x ) .$$

This expression represents the product of three terms:
The price p.

$$1 - \frac{p}{R - r} .$$

The number of customers to whom the offer is made: n+x.

### Revenue-Maximizing Price (“RMP”) and Stock-Clearing Price (“SCP”)

In the case where there is an unlimited number of premium rooms available, the revenue-maximizing price (“RMP”) can be determined by maximizing the revenue function:

$${p}_{RMP} = \frac{R - r}{2} .$$

This price balances the trade-off between price and the likelihood of upgrade acceptance.

However, when the number of premium rooms is limited, the optimal price must take into account the stock-clearing price (“SCP”), which ensures that all premium rooms are sold. The SCP is given by:

$${p}_{S C P} = ( 1 - \frac{x}{n + x} ) ( R - r ) ,$$

where

$$\frac{x}{n + x}$$

represents the proportion or rooms that are overbooked relative to the total capacity of the standard category.

The optimal price in the case of limited rooms is the maximum of the RMP and SCP:

$${p}^{*} ( x ) = max ( \frac{n}{n + x} , \frac{1}{2} ) ( R - r ) .$$

Marginal Revenue Change with Overbooking

The change in revenue as a result of overbooking additional standard rooms into the premium category is given by:

$$\frac{\partial R e v ( {p}^{*} ( x ) , x )}{\partial x} = \frac{{n}^{2}}{{( n + x )}^{2}} ( R - r ) , \qquad x \leq n ,$$

$$and :$$

$$\frac{1}{4} ( R - r ) , \qquad if x > n .$$

This equation reflects the diminishing returns on revenue as more standard rooms are overbooked into premium rooms.

### Log-Linear Demand Case

In the log-linear demand model, the probability of accepting an upgrade decreases exponentially with price. Let β be the price sensitivity coefficient, such that the probability of accepting an upgrade at price p is:

$$ℙ ( accept upgrade ) = {e}^{- β p} .$$

The SCP in the log-linear case is found by solving the equation:

$$x = ( n + x ) {e}^{- β {p}_{SCP}} ,$$

which gives:

$${p}_{SCP} = \frac{1}{β} log \frac{n + x}{x} .$$

The RMP in this case is:

$${p}_{RMP} = \frac{1}{β} .$$

Thus, the optimal price for upgrades under log-linear demand is:

$${p}^{*} ( x ) = \frac{1}{β} max ( log \frac{n + x}{x} , 1 ) .$$

The optimal revenue from paid upgrades, as a function of overbooking x, is:

$$Rev ( {p}^{*} ( x ) , x ) = \frac{x}{β} log \frac{n + x}{x} , \qquad if x \leq \frac{n}{e - 1} ,$$

$$and :$$

$$\frac{n + x}{β e} , \qquad if x > \frac{n}{e - 1} .$$

At 505, the marginal change in revenue with respect to overbooking is:

$$\begin{matrix}\frac{\partial R e v ( {p}^{*} ( x ) , x )}{\partial x} = \frac{1}{β} ( log \frac{n + x}{x} - \frac{n}{n + x} ) , & if x \leq \frac{n}{e - 1}\end{matrix} ,$$

$$and :$$

$$\begin{matrix}\frac{1}{β e} , & if x \leq \frac{n}{e - 1}\end{matrix} .$$

### Determining the Booking Limit

The optimal booking limit in the premium category is determined at 507 by solving the following equation for x in order to find the optimal solution

$${x}^{*} : r + \frac{\partial R e v ( {p}^{*} ( x ) , x )}{\partial x} = ( 1 - {F}_{Y} ( N - {x}^{*} ) ) R$$

which essentially states that the optimal solution is reached when the marginal revenue from increasing the standard room booking and offering additional paid upgrades is equal to the marginal loss of booking opportunities in the premium category. The above equation can also be rewritten as follows:

$${x}^{*} = N - {F}_{Y - {Z}^{+} ( {x}^{*} )}^{- 1} ( 1 - \frac{r + \frac{\partial R e v ( x )}{\partial x}}{R} ) . \qquad ( Equation 1 )$$

In Equation 1, the additional revenue from upgrades is incorporated into the booking decision.

Embodiments assume that both Y and Z follow normal distributions. Therefore, Y−Z also follows a normal distribution:

$$Y - Z ∼ N ( {μ}_{Y} - {μ}_{Z} , \sqrt{{σ}_{Y}^{2} + {σ}_{Z}^{2}} ) ,$$

which allows the inverse CDF required to solve for x to be efficiently computed.

### Example

As an example of the functionality of FIG. 5, consider an embodiment with the following parameters:

| Parameters | Standard | Premium |
|---|---|---|
| Number of rooms | 200 | 80 |
| Revenue per room | $80 | $180 |

Additionally, assume the following distributions:

$$\begin{matrix}Premium Demand \sim N ( μ = 60 , σ = 15 ) \\ Standard Collection \sim N ( μ = 20 , σ = 8 )\end{matrix}$$

Linear and log-linear (β=0.053) offer acceptance probability as a function of price

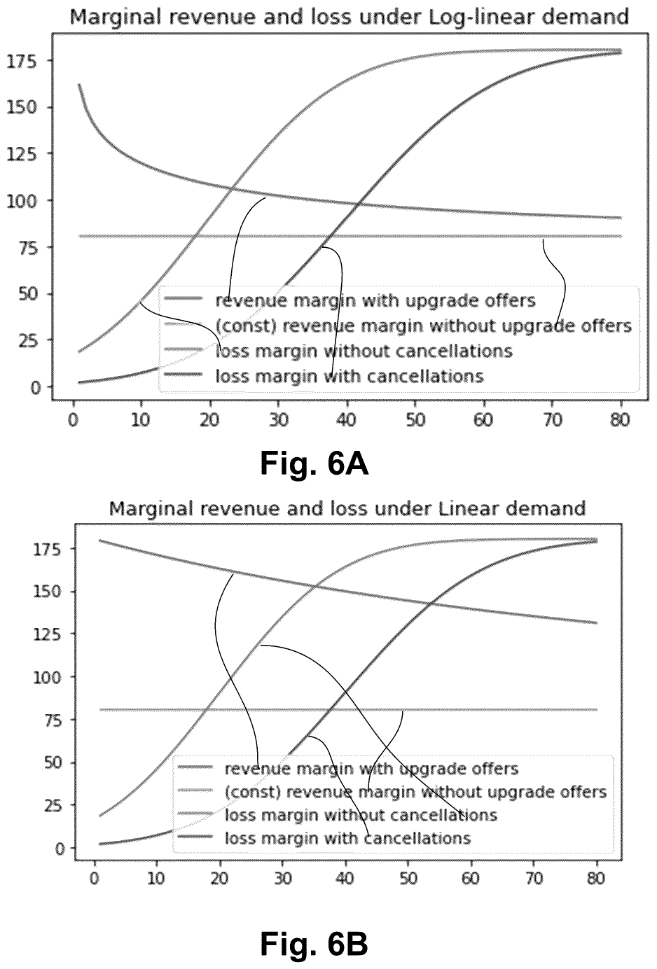

FIGS. 6A and 6B are graphs that plot the loss and revenue margins as functions of the number of rooms overbooked in accordance to embodiments. FIG. 6A represents the log-linear demand model, and FIG. 6B represents a linear demand model. The four intersection points in each plots are optimal solutions for the respective scenarios that include paid and non-paid upgrades for the standard room marginal revenue curves and accounting and non-accounting for the cancellations in the premium room category marginal loss calculations.

### Multi-Day Stay Admission Strategy

Embodiments enhance revenue management by adjusting multi-day standard room reservation acceptance based on the total marginal revenue versus the marginal loss in the premium category. The multi-day functionality differs from the single-day embodiment in two ways: (1) instead of computing an a-priori booking limit, it provides an admission condition for each individual multi-day reservation; and (2) it aggregates each single day marginal revenue and opportunity loss by summing them up over the entire length of the reservation.

Embodiments assume that a new standard reservation with overbooking in the premium category on some of its days is admitted if the total marginal revenue it generates is greater than the total marginal loss of space in the premium category. This deviates from traditional per-day “hard” constraints by considering the overall impact of the reservation across multiple days.

Reservation Admission Condition: Instead of setting a-priori per-day booking limits, embodiments admits each new reservation based on the total difference between marginal revenue and opportunity loss, depending on the current per-day booking levels, x_{d}. Suppose a particular reservation is booked from day d₁ to d₂ for the total rate rₜₒₜ. Then aggregating the conditions from Equation 1 above, the reservation admission condition can be expressed as:

$${r}_{t o t} + {\sum }_{d = {d}_{1}}^{{d}_{2} - 1} \frac{\partial R e v ( {x}_{d} )}{\partial x} \geq {\sum }_{d = {d}_{1}}^{{d}_{2} - 1} ( 1 - {F}_{Y} ( N - {x}_{t} ) ) {R}_{d}$$

### Where:

rₜₒₜ is the total revenue generated by the new reservation.

$$\frac{\partial Rev ( {x}_{t} )}{\partial x}$$

is the marginal revenue from each additional booking.
F_{Y} is the cumulative distribution function (“CDF”) representing the probability of booking the premium category.
N−xₜ is the remaining capacity in the premium category for each day t.
Rₜ is the revenue potential for each day t.
   This condition allows high-revenue, multi-day reservations to be accepted even if they are suboptimal on certain days but compensate with higher revenues on others.

Whereas the above approach implements an admission control procedure per single booking reservations, its disadvantage is that it is generally considered a greedy algorithm (i.e., an algorithm without knowledge of the future reservation arrivals), which may result in admitting less valuable reservations and thus delivering a suboptimal solution. When there is an information available about the general distribution of the arrivals, with embodiments, the following steps are followed to implement a dynamic reservation strategy that implements admission control using so-called dual costs or shadow prices of the resources:
1. Prediction of Future Reservations: Begin by generating predictions for future demand based on historical data and relevant forecasting methods.
2. Generate Random Demand Sample: Create a random sample of future demand scenarios to simulate the possible booking environment.
3. Solve the Admission Control as a Linear Programming (LP) Problem: Formulate the reservation admission problem as a multi-constraint knapsack problem and solve it using linear programming. This will help determine which reservations maximize revenue while adhering to capacity constraints.
4. Obtain Dual Costs of Constraints: From the LP solution, extract the dual costs associated with the constraints. These dual costs represent the marginal cost of violating the capacity constraints.
5. Repeat and Average the Costs: Repeat the process for multiple demand scenarios and compute the average constraint costs over all samples. This provides a more robust estimate of the opportunity cost for each constraint.
   This structured approach for managing reservations focuses on maximizing revenue while balancing capacity constraints, with a more dynamic and flexible strategy.

### Dynamic Run-Out Pricing for Perishable Goods

As disclosed, at 504 embodiments determine an optimal upgrade price as a function of overbooked rooms. One embodiment implements an interpretable and asymptotically optimal pricing strategy, referred to as the “Dynamic Run-Out Price” (“DROP”), which adjusts the upgrade price for each customer based on real-time inventory and anticipated future arrivals. Embodiments provide a dynamic check-in upgrade feature that allows hotels to offer guests the option of upgrading their standard room to a premium one at a discounted rate at the time of check-in, in order to optimize revenue.

Known simple pricing models are easy to implement but can lead to significant revenue loss due to their sub-optimality. On the other hand, more sophisticated models, such as those leveraging deep learning, may approach optimal pricing but are often too complex to interpret and apply in a practical hotel setting. This creates a trade-off between simplicity and optimality, where hotels must either sacrifice profitability or ease of implementation. In contrast, embodiments balance these two extremes by offering a pricing strategy that is both interpretable and near-optimal. Embodiments dynamically adjust upgrade prices based on real-time inventory and anticipated guest arrivals, ensuring that hotels can maximize revenue while maintaining operational simplicity.

In contrast to traditional pricing models, with embodiments, the seller (hotel) has a fairly accurate estimate of the total number of potential customers, assuming no unexpected walk-ins or no-shows. This is because the customer pool is limited to guests already staying in basic rooms. In contrast, many typical pricing scenarios involve uncertainty around the number of potential buyers, making demand forecasting and pricing strategies more complex. However, with hotel upgrades, the fixed set of potential customers allows for a more precise and efficient pricing algorithm.

Additionally, since embodiments are pricing upgrades at the time of check-in, the maximum price that can be set for an upgrade is constrained by the price difference between room categories at the time of booking. In other words, the customers' willingness to pay is inherently bounded by this initial price difference, as guests are unlikely to pay more for an upgrade than they would have when booking. This limitation ensures that upgrade pricing remains within reasonable limits and reflects the original pricing structure, which helps to optimize revenue while maintaining customer satisfaction. Because of this, embodiments implement bounded distributions as well as exponential distribution.

One embodiment focuses on a simplified scenario where each night of a stay is treated as an independent purchase opportunity. Specifically, each night is priced individually, so for a multi-night stay, the total price is simply the sum of the prices for each individual night. This approach assumes that the demand for consecutive nights is uncorrelated, allowing embodiments to relax the complexity that would arise from modeling demand correlations across multiple nights. Other embodiments may fully capture the dynamics of multi-night bookings.

One embodiment is directed to the instance where the inventory is small, while the number of potential customers is large. This scenario is highly relevant in the context of hotel upgrades, where a hotel typically has only a handful of luxury rooms available for upgrade but may have a large number of guests staying in basic rooms. For example, a hotel might have around 200 guests in standard rooms but only a few premium rooms available. This imbalance between supply and demand plays a critical role in shaping the optimal pricing strategy, as the hotel must carefully manage its limited inventory to maximize revenue from a large pool of potential buyers.

Embodiments are directed to a dynamic pricing algorithm that converges to optimal revenue under specific distributions as the number of customers who booked basic rooms, increases. Embodiments establish these results under two subclasses of willingness-to-pay distributions: bounded and exponential. The bounded distribution is particularly relevant, as the price of an upgrade should generally be lower than the original price difference between premium and basic rooms. This relationship ensures that embodiments are well-aligned with the practical pricing strategies employed in the hospitality industry.

### Notations

For a non-negative integer n the notation [n] specifies the set of all non-negative integers less than or equal to n. k, n are used as the state variable of the dynamic programmings where k is defined as the remaining inventory and n indicates the number of remaining potential customers.
Definition 1. For a distribution with a continuous cumulative distribution function (CDF) F(.), define function q̅_{F}:[0,1]→ [symbol] to be inverse of the function 1−F(.). That is,

$${\overline{q}}_{F} ( x ) = p ⇔ 1 - F ( p ) = x$$

In other words, if F(.) represents the distribution of customers' willingness to pay, then q̅_{F}(x) denotes the price at which buyers are willing to purchase the item with a probability of x.
Definition 2. A willingness to pay distribution is called bounded if there exists a price p̅ such that no customer makes a purchase at a higher price; in other words, F(p̅)=1.
Definition 3. A willingness to pay distribution is defined as exponential if its CDF takes the form F(p)=1−e^{-cp} for some constant c.

For any exponential distribution, one can assume c=1 without loss of generality by adjusting the scale. Thus, for simplicity, embodiments assume c=1 when discussing exponential distributions, leading to the form F(p)=1−e^{-p}.
Definition 4. The Harmonic number Hₙ is defined as the sum of the reciprocals of the first n positive integers. It can be expressed mathematically as:

$${H}_{n} = {\sum }_{i = 1}^{n} \frac{1}{i}$$

### Preliminaries

A monopolist seller has an initial inventory of K units of a single item and N potential customers, each with their own random utility (or willingness-to-pay) for the item. The buyers are homogeneous and arrive sequentially, each observing their i.i.d utility vᵢ, drawn from a fixed utility distribution with continuous CDF F(.). After observing the price pᵢ, the buyer i decides to buy the item if vᵢ≥pᵢ and leave without making a purchase otherwise. This implies by setting price pᵢ a purchase happens with probability 1−F(pᵢ).

The seller's problem is to determine the optimal prices (pᵢ)_{i∈[N]} that maximize total expected revenue. This optimization can be formulated as a dynamic programming problem, characterized by a state space of [symbol] × [symbol] and defined by the following Bellman equation for the value function V(.,.):

$$V ( k , n ) = {max}_{p} F ( p ) V ( k , n - 1 ) + ( 1 - F ( p ) ) ( V ( k - 1 , n - 1 ) + p )$$

Where the first term reflects the scenario in which the buyer does not make a purchase, and the second term is for the case when a purchase is made. Hence the seller is maximizing V(k, n) with the boundary condition V(.,0)=V(0,.)=0.

Defining the state as a pair (k, n) is valid as the seller has complete information about the inventory level and future arrivals. Embodiments are directed to a dynamic pricing algorithm, referred to as Dynamic Run-Out Pricing (“DROP”), that sets the price in state (k, n) such that the probability of the next customer making a purchase is equal to k/n. This approach is grounded in the fluid approximation of the problem, which involves solving the following linear programming (“LP”) relaxation of the original discrete problem:

$${max}_{p} p \cdot min ( k , n ( 1 - F ( p ) ) )$$

This LP relaxation simplifies the constraints by allowing fractional values (1−F(p) by setting price p) for customer's purchase, making the problem more tractable. The relaxation focuses on maximizing expected revenue by determining an optimal pricing strategy. By aligning the pricing strategy with the solution derived from this LP relaxation, a balance between future revenue from keeping the item and selling to the very next customer is maintained, while also optimizing inventory usage.

The solution to the above LP relaxation involves setting the price such that the expected demand, given by n(1−F(p), equals the total inventory k. Consequently, DROP determines the price as

$$p = {\overline{q}}_{F} ( \frac{k}{n} ) .$$

This relationship implies that the seller sets the price based on the quantile function of the customers' willingness to pay, adjusted for the ratio of inventory to expected customer arrivals. Therefore, the recursion for updating the price can be expressed as follows:

$$D ( k , n ) = ( 1 - \frac{k}{n} ) D ( k , n - 1 ) + \frac{k}{n} ( D ( k - 1 , n - 1 ) + {\overline{q}}_{F} ( \frac{k}{n} ) )$$

In embodiments, DROP is less effective in scenarios with small n. In particular, when n=k, the price should be set to 0 since the probability of purchase is supposed to be 1. However, for high-demand conditions (large N), setting an near-optimal price for situations where k/n is large is not crucial for convergence.

### Main Results

The following proposition serves as a benchmark to compare the performance of embodiments:

The Static run-out price (“SROP”) sells asymptotically

$$k - {e}^{- k} \frac{{k}^{k}}{( k - 1 ) !}$$

items on average as the total number of buyers n approaches infinity. The expected revenue of the SROP is asymptotically equal to:

$${\overline{q}}_{F} ( \frac{k}{n} ) ( k - {e}^{- k} \frac{{k}^{k}}{( k - 1 ) !} )$$

### Bounded Distribution

For any bounded willingness to pay distribution F(.),

$${lim}_{n \to ∞} [ D ( k , n ) - V ( k , n ) ] = 0$$

Let p̅ be the upper bound of the distribution F(.). It is straightforward to observe that D(k,n)≤V(k,n)≤p̅k. Therefore, by proving that lim_{n→∞}D(k, n)=p̅k and applying the Squeeze Theorem, it can be concluded that:

$${lim}_{n \to ∞} D ( k , n ) = {lim}_{n \to ∞} V ( k , n ) = \overline{p} k$$

As a result, the proof of reduces to the following proposition:

For any bounded willingness to pay distribution F(.),

$${lim}_{n \to ∞} D ( k , n ) = \overline{p} k$$

### Exponential Distribution

Embodiments are further directed to exponential distributions. In the above, embodiments relied on the existence of an upper bound for the revenue and demonstrated that this bound is achieved by the DROP when the number of customers becomes large. However, this approach cannot be applied in the case of exponential distributions, as the distribution is unbounded above.

For an exponential willingness to pay distribution F(.),

$${lim}_{n \to ∞} [ D ( k , n ) - V ( k , n ) ] = 0$$

To prove this theorem, embodiments determined that both expressions k log(n)−D(k,n) (in) and k log(n)−V(k,n) (in) converge to the same value, k+log(k!).

$$\begin{matrix}{lim}_{n \to ∞} [ k log ( n ) - D ( k , n ) ] = k + log ( k ! ) \\ {lim}_{n \to ∞} [ k log ( n ) - V ( k , n ) ] = k + log ( k ! )\end{matrix}$$

Thus, by considering the difference of k log(n)−V(k, n) and k log(n)−D(k, n), which both converge to the same value, k+log(k!), embodiments establish that the difference between D(k,n) and V(k, n) approaches zero as n approaches infinity. This provide proof of the efficiency of embodiments under exponential willingness-to-pay distributions.

### Example Cloud Infrastructure

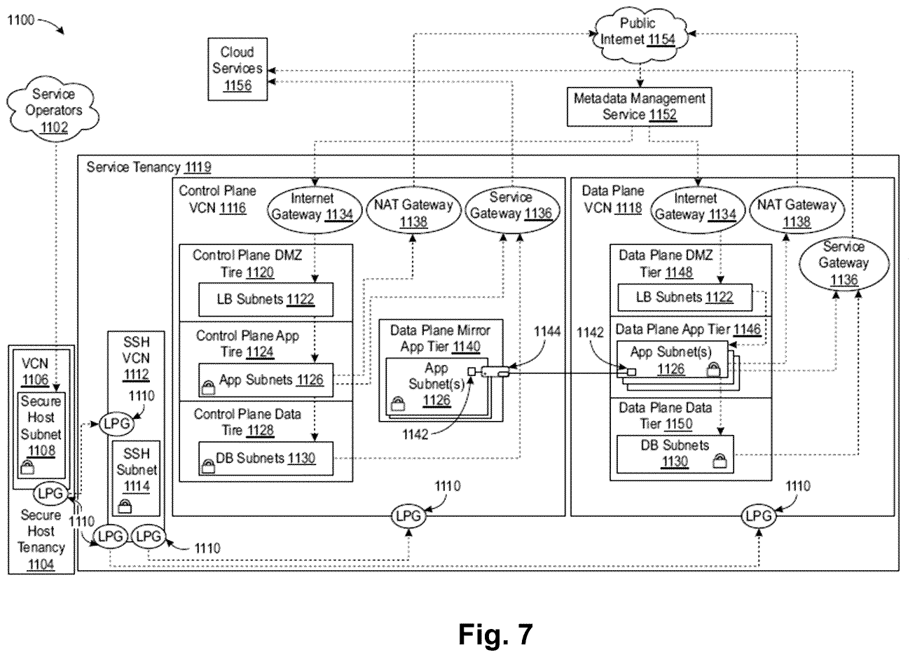

FIGS. 7-10 illustrate an example cloud infrastructure that can implement hotel chain operations 104 that can include overbooking optimization module 16 of FIG. 2 in accordance to embodiments.

As disclosed above, infrastructure as a service (“IaaS”) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (e.g., billing, monitoring, logging, security, load balancing and clustering, etc.). Thus, as these services may be policy-driven, IaaS users may be able to implement policies to drive load balancing to maintain application availability and performance.

In some instances, IaaS customers may access resources and services through a wide area network (“WAN”), such as the Internet, and can use the cloud provider's services to install the remaining elements of an application stack. For example, the user can log in to the IaaS platform to create virtual machines (“VM”s), install operating systems (“OS”s) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different problems for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (“VPC”s) (e.g., a potentially on-demand pool of configurable and/or shared computing resources), also known as a core network. In some examples, there may also be one or more security group rules provisioned to define how the security of the network will be set up and one or more virtual machines. Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 7 is a block diagram 1100 illustrating an example pattern of an IaaS architecture, according to at least one embodiment. Service operators 1102 can be communicatively coupled to a secure host tenancy 1104 that can include a virtual cloud network (“VCN”) 1106 and a secure host subnet 1108. In some examples, the service operators 1102 may be using one or more client computing devices, which may be portable handheld devices (e.g., an iPhone®, cellular telephone, an iPad®, computing tablet, a personal digital assistant (“PDA”)) or wearable devices (e.g., a Meta Quest® head mounted display), running software such as Microsoft Windows Mobile®, and/or a variety of mobile operating systems such as iOS, Windows Phone, Android, BlackBerry 8, Palm OS, and the like, and being Internet, e-mail, short message service (“SMS”), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 1106 and/or the Internet.

The VCN 1106 can include a local peering gateway (“LPG”) 1110 that can be communicatively coupled to a secure shell (“SSH”) VCN 1112 via an LPG 1110 contained in the SSH VCN 1112. The SSH VCN 1112 can include an SSH subnet 1114, and the SSH VCN 1112 can be communicatively coupled to a control plane VCN 1116 via the LPG 1110 contained in the control plane VCN 1116. Also, the SSH VCN 1112 can be communicatively coupled to a data plane VCN 1118 via an LPG 1110. The control plane VCN 1116 and the data plane VCN 1118 can be contained in a service tenancy 1119 that can be owned and/or operated by the IaaS provider.

The control plane VCN 1116 can include a control plane demilitarized zone (“DMZ”) tier 1120 that acts as a perimeter network (e.g., portions of a corporate network between the corporate intranet and external networks). The DMZ-based servers may have restricted responsibilities and help keep security breaches contained. Additionally, the DMZ tier 1120 can include one or more load balancer (“LB”) subnet(s) 1122, a control plane app tier 1124 that can include app subnet(s) 1126, a control plane data tier 1128 that can include database (DB) subnet(s) 1130 (e.g., frontend DB subnet(s) and/or backend DB subnet(s)). The LB subnet(s) 1122 contained in the control plane DMZ tier 1120 can be communicatively coupled to the app subnet(s) 1126 contained in the control plane app tier 1124 and an Internet gateway 1134 that can be contained in the control plane VCN 1116, and the app subnet(s) 1126 can be communicatively coupled to the DB subnet(s) 1130 contained in the control plane data tier 1128 and a service gateway 1136 and a network address translation (NAT) gateway 1138. The control plane VCN 1116 can include the service gateway 1136 and the NAT gateway 1138.

The control plane VCN 1116 can include a data plane mirror app tier 1140 that can include app subnet(s) 1126. The app subnet(s) 1126 contained in the data plane mirror app tier 1140 can include a virtual network interface controller (VNIC) 1142 that can execute a compute instance 1144. The compute instance 1144 can communicatively couple the app subnet(s) 1126 of the data plane mirror app tier 1140 to app subnet(s) 1126 that can be contained in a data plane app tier 1146.

The data plane VCN 1118 can include the data plane app tier 1146, a data plane DMZ tier 1148, and a data plane data tier 1150. The data plane DMZ tier 1148 can include LB subnet(s) 1122 that can be communicatively coupled to the app subnet(s) 1126 of the data plane app tier 1146 and the Internet gateway 1134 of the data plane VCN 1118. The app subnet(s) 1126 can be communicatively coupled to the service gateway 1136 of the data plane VCN 1118 and the NAT gateway 1138 of the data plane VCN 1118. The data plane data tier 1150 can also include the DB subnet(s) 1130 that can be communicatively coupled to the app subnet(s) 1126 of the data plane app tier 1146.

The Internet gateway 1134 of the control plane VCN 1116 and of the data plane VCN 1118 can be communicatively coupled to a metadata management service 1152 that can be communicatively coupled to public Internet 1154. Public Internet 1154 can be communicatively coupled to the NAT gateway 1138 of the control plane VCN 1116 and of the data plane VCN 1118. The service gateway 1136 of the control plane VCN 1116 and of the data plane VCN 1118 can be communicatively coupled to cloud services 1156.

In some examples, the service gateway 1136 of the control plane VCN 1116 or of the data plane VCN 1118 can make application programming interface (“API”) calls to cloud services 1156 without going through public Internet 1154. The API calls to cloud services 1156 from the service gateway 1136 can be one-way: the service gateway 1136 can make API calls to cloud services 1156, and cloud services 1156 can send requested data to the service gateway 1136. But, cloud services 1156 may not initiate API calls to the service gateway 1136.

In some examples, the secure host tenancy 1104 can be directly connected to the service tenancy 1119, which may be otherwise isolated. The secure host subnet 1108 can communicate with the SSH subnet 1114 through an LPG 1110 that may enable two-way communication over an otherwise isolated system. Connecting the secure host subnet 1108 to the SSH subnet 1114 may give the secure host subnet 1108 access to other entities within the service tenancy 1119.

The control plane VCN 1116 may allow users of the service tenancy 1119 to set up or otherwise provision desired resources. Desired resources provisioned in the control plane VCN 1116 may be deployed or otherwise used in the data plane VCN 1118. In some examples, the control plane VCN 1116 can be isolated from the data plane VCN 1118, and the data plane mirror app tier 1140 of the control plane VCN 1116 can communicate with the data plane app tier 1146 of the data plane VCN 1118 via VNICs 1142 that can be contained in the data plane mirror app tier 1140 and the data plane app tier 1146.

In some examples, users of the system, or customers, can make requests, for example create, read, update, or delete (“CRUD”) operations, through public Internet 1154 that can communicate the requests to the metadata management service 1152. The metadata management service 1152 can communicate the request to the control plane VCN 1116 through the Internet gateway 1134. The request can be received by the LB subnet(s) 1122 contained in the control plane DMZ tier 1120. The LB subnet(s) 1122 may determine that the request is valid, and in response to this determination, the LB subnet(s) 1122 can transmit the request to app subnet(s) 1126 contained in the control plane app tier 1124. If the request is validated and requires a call to public Internet 1154, the call to public Internet 1154 may be transmitted to the NAT gateway 1138 that can make the call to public Internet 1154. Memory that may be desired to be stored by the request can be stored in the DB subnet(s) 1130.

In some examples, the data plane mirror app tier 1140 can facilitate direct communication between the control plane VCN 1116 and the data plane VCN 1118. For example, changes, updates, or other suitable modifications to configuration may be desired to be applied to the resources contained in the data plane VCN 1118. Via a VNIC 1142, the control plane VCN 1116 can directly communicate with, and can thereby execute the changes, updates, or other suitable modifications to configuration to, resources contained in the data plane VCN 1118.

In some embodiments, the control plane VCN 1116 and the data plane VCN 1118 can be contained in the service tenancy 1119. In this case, the user, or the customer, of the system may not own or operate either the control plane VCN 1116 or the data plane VCN 1118. Instead, the IaaS provider may own or operate the control plane VCN 1116 and the data plane VCN 1118, both of which may be contained in the service tenancy 1119. This embodiment can enable isolation of networks that may prevent users or customers from interacting with other users', or other customers', resources. Also, this embodiment may allow users or customers of the system to store databases privately without needing to rely on public Internet 1154, which may not have a desired level of security, for storage.

In other embodiments, the LB subnet(s) 1122 contained in the control plane VCN 1116 can be configured to receive a signal from the service gateway 1136. In this embodiment, the control plane VCN 1116 and the data plane VCN 1118 may be configured to be called by a customer of the IaaS provider without calling public Internet 1154. Customers of the IaaS provider may desire this embodiment since database(s) that the customers use may be controlled by the IaaS provider and may be stored on the service tenancy 1119, which may be isolated from public Internet 1154.

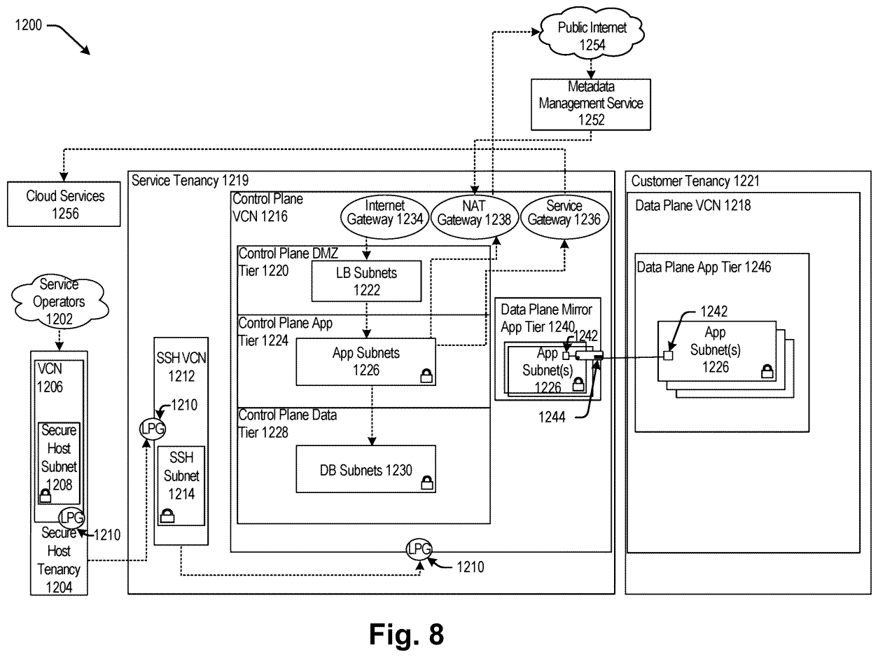

FIG. 8 is a block diagram 1200 illustrating another example pattern of an IaaS architecture, according to at least one embodiment. Service operators 1202 (e.g. service operators 1102) can be communicatively coupled to a secure host tenancy 1204 (e.g. the secure host tenancy 1104) that can include a virtual cloud network (VCN) 1206 (e.g. the VCN 1106) and a secure host subnet 1208 (e.g. the secure host subnet 1108). The VCN 1206 can include a local peering gateway (LPG) 1210 (e.g. the LPG 1110) that can be communicatively coupled to a secure shell (SSH) VCN 1212 (e.g. the SSH VCN 1112 10) via an LPG 1110 contained in the SSH VCN 1212. The SSH VCN 1212 can include an SSH subnet 1214 (e.g. the SSH subnet 1114), and the SSH VCN 1212 can be communicatively coupled to a control plane VCN 1216 (e.g. the control plane VCN 1116) via an LPG 1210 contained in the control plane VCN 1216. The control plane VCN 1216 can be contained in a service tenancy 1219 (e.g. the service tenancy 1119), and the data plane VCN 1218 (e.g. the data plane VCN 1118) can be contained in a customer tenancy 1221 that may be owned or operated by users, or customers, of the system.

The control plane VCN 1216 can include a control plane DMZ tier 1220 (e.g. the control plane DMZ tier 1120) that can include LB subnet(s) 1222 (e.g. LB subnet(s) 1122), a control plane app tier 1224 (e.g. the control plane app tier 1124) that can include app subnet(s) 1226 (e.g. app subnet(s) 1126), a control plane data tier 1228 (e.g. the control plane data tier 1128) that can include database (DB) subnet(s) 1230 (e.g. similar to DB subnet(s) 1130). The LB subnet(s) 1222 contained in the control plane DMZ tier 1220 can be communicatively coupled to the app subnet(s) 1226 contained in the control plane app tier 1224 and an Internet gateway 1234 (e.g. the Internet gateway 1134) that can be contained in the control plane VCN 1216, and the app subnet(s) 1226 can be communicatively coupled to the DB subnet(s) 1230 contained in the control plane data tier 1228 and a service gateway 1236 and a network address translation (NAT) gateway 1238 (e.g. the NAT gateway 1138). The control plane VCN 1216 can include the service gateway 1236 and the NAT gateway 1238.

The control plane VCN 1216 can include a data plane mirror app tier 1240 (e.g. the data plane mirror app tier 1140) that can include app subnet(s) 1226. The app subnet(s) 1226 contained in the data plane mirror app tier 1240 can include a virtual network interface controller (VNIC) 1242 (e.g. the VNIC of 1142) that can execute a compute instance 1244 (e.g. similar to the compute instance 1144). The compute instance 1244 can facilitate communication between the app subnet(s) 1226 of the data plane mirror app tier 1240 and the app subnet(s) 1226 that can be contained in a data plane app tier 1246 (e.g. the data plane app tier 1146) via the VNIC 1242 contained in the data plane mirror app tier 1240 and the VNIC 1242 contained in the data plane app tier 1246.

The Internet gateway 1234 contained in the control plane VCN 1216 can be communicatively coupled to a metadata management service 1252 (e.g. the metadata management service 1152) that can be communicatively coupled to public Internet 1254 (e.g. public Internet 1154). Public Internet 1254 can be communicatively coupled to the NAT gateway 1238 contained in the control plane VCN 1216. The service gateway 1236 contained in the control plane VCN 1216 can be communicatively couple to cloud services 1256 (e.g. cloud services 1156).

In some examples, the data plane VCN 1218 can be contained in the customer tenancy 1221. In this case, the IaaS provider may provide the control plane VCN 1216 for each customer, and the IaaS provider may, for each customer, set up a unique compute instance 1244 that is contained in the service tenancy 1219. Each compute instance 1244 may allow communication between the control plane VCN 1216, contained in the service tenancy 1219, and the data plane VCN 1218 that is contained in the customer tenancy 1221. The compute instance 1244 may allow resources that are provisioned in the control plane VCN 1216 that is contained in the service tenancy 1219, to be deployed or otherwise used in the data plane VCN 1218 that is contained in the customer tenancy 1221.

In other examples, the customer of the IaaS provider may have databases that live in the customer tenancy 1221. In this example, the control plane VCN 1216 can include the data plane mirror app tier 1240 that can include app subnet(s) 1226. The data plane mirror app tier 1240 can reside in the data plane VCN 1218, but the data plane mirror app tier 1240 may not live in the data plane VCN 1218. That is, the data plane mirror app tier 1240 may have access to the customer tenancy 1221, but the data plane mirror app tier 1240 may not exist in the data plane VCN 1218 or be owned or operated by the customer of the IaaS provider. The data plane mirror app tier 1240 may be configured to make calls to the data plane VCN 1218, but may not be configured to make calls to any entity contained in the control plane VCN 1216. The customer may desire to deploy or otherwise use resources in the data plane VCN 1218 that are provisioned in the control plane VCN 1216, and the data plane mirror app tier 1240 can facilitate the desired deployment, or other usage of resources, of the customer.

In some embodiments, the customer of the IaaS provider can apply filters to the data plane VCN 1218. In this embodiment, the customer can determine what the data plane VCN 1218 can access, and the customer may restrict access to public Internet 1254 from the data plane VCN 1218. The IaaS provider may not be able to apply filters or otherwise control access of the data plane VCN 1218 to any outside networks or databases. Applying filters and controls by the customer onto the data plane VCN 1218, contained in the customer tenancy 1221, can help isolate the data plane VCN 1218 from other customers and from public Internet 1254.

In some embodiments, cloud services 1256 can be called by the service gateway 1236 to access services that may not exist on public Internet 1254, on the control plane VCN 1216, or on the data plane VCN 1218. The connection between cloud services 1256 and the control plane VCN 1216 or the data plane VCN 1218 may not be live or continuous. Cloud services 1256 may exist on a different network owned or operated by the IaaS provider. Cloud services 1256 may be configured to receive calls from the service gateway 1236 and may be configured to not receive calls from public Internet 1254. Some cloud services 1256 may be isolated from other cloud services 1256, and the control plane VCN 1216 may be isolated from cloud services 1256 that may not be in the same region as the control plane VCN 1216. For example, the control plane VCN 1216 may be located in “Region 1,” and cloud service “Deployment 8,” may be located in Region 1 and in “Region 2.” If a call to Deployment 8 is made by the service gateway 1236 contained in the control plane VCN 1216 located in Region 1, the call may be transmitted to Deployment 8 in Region 1. In this example, the control plane VCN 1216, or Deployment 8 in Region 1, may not be communicatively coupled to, or otherwise in communication with, Deployment 8 in Region 2.

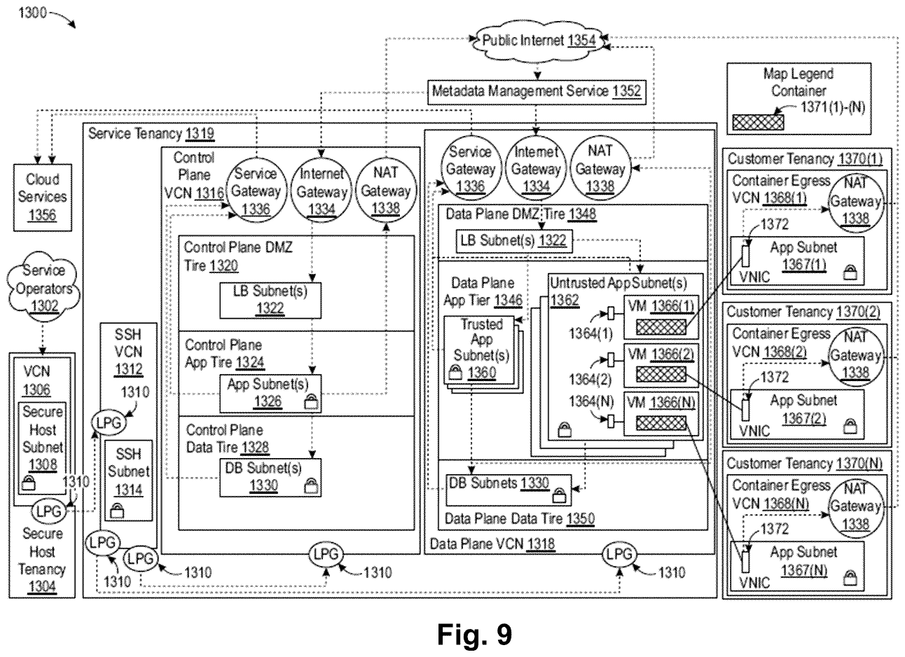

FIG. 9 is a block diagram 1300 illustrating another example pattern of an IaaS architecture, according to at least one embodiment. Service operators 1302 (e.g. service operators 1102) can be communicatively coupled to a secure host tenancy 1304 (e.g. the secure host tenancy 1104) that can include a virtual cloud network (VCN) 1306 (e.g. the VCN 1106) and a secure host subnet 1308 (e.g. the secure host subnet 1108). The VCN 1306 can include an LPG 1310 (e.g. the LPG 1110) that can be communicatively coupled to an SSH VCN 1312 (e.g. the SSH VCN 1112) via an LPG 1310 contained in the SSH VCN 1312. The SSH VCN 1312 can include an SSH subnet 1314 (e.g. the SSH subnet 1114), and the SSH VCN 1312 can be communicatively coupled to a control plane VCN 1316 (e.g. the control plane VCN 1116) via an LPG 1310 contained in the control plane VCN 1316 and to a data plane VCN 1318 (e.g. the data plane 1118) via an LPG 1310 contained in the data plane VCN 1318. The control plane VCN 1316 and the data plane VCN 1318 can be contained in a service tenancy 1319 (e.g. the service tenancy 1119).

The control plane VCN 1316 can include a control plane DMZ tier 1320 (e.g. the control plane DMZ tier 1120) that can include load balancer (“LB”) subnet(s) 1322 (e.g. LB subnet(s) 1122), a control plane app tier 1324 (e.g. the control plane app tier 1124) that can include app subnet(s) 1326 (e.g. similar to app subnet(s) 1126), a control plane data tier 1328 (e.g. the control plane data tier 1128) that can include DB subnet(s) 1330. The LB subnet(s) 1322 contained in the control plane DMZ tier 1320 can be communicatively coupled to the app subnet(s) 1326 contained in the control plane app tier 1324 and to an Internet gateway 1334 (e.g. the Internet gateway 1134) that can be contained in the control plane VCN 1316, and the app subnet(s) 1326 can be communicatively coupled to the DB subnet(s) 1330 contained in the control plane data tier 1328 and to a service gateway 1336 (e.g. the service gateway) and a network address translation (NAT) gateway 1338 (e.g. the NAT gateway 1138). The control plane VCN 1316 can include the service gateway 1336 and the NAT gateway 1338.

The data plane VCN 1318 can include a data plane app tier 1346 (e.g. the data plane app tier 1146), a data plane DMZ tier 1348 (e.g. the data plane DMZ tier 1148), and a data plane data tier 1350 (e.g. the data plane data tier 1150). The data plane DMZ tier 1348 can include LB subnet(s) 1322 that can be communicatively coupled to trusted app subnet(s) 1360 and untrusted app subnet(s) 1362 of the data plane app tier 1346 and the Internet gateway 1334 contained in the data plane VCN 1318. The trusted app subnet(s) 1360 can be communicatively coupled to the service gateway 1336 contained in the data plane VCN 1318, the NAT gateway 1338 contained in the data plane VCN 1318, and DB subnet(s) 1330 contained in the data plane data tier 1350. The untrusted app subnet(s) 1362 can be communicatively coupled to the service gateway 1336 contained in the data plane VCN 1318 and DB subnet(s) 1330 contained in the data plane data tier 1350. The data plane data tier 1350 can include DB subnet(s) 1330 that can be communicatively coupled to the service gateway 1336 contained in the data plane VCN 1318.

The untrusted app subnet(s) 1362 can include one or more primary VNICs 1364(1)-(N) that can be communicatively coupled to tenant virtual machines (VMs) 1366(1)-(N). Each tenant VM 1366(1)-(N) can be communicatively coupled to a respective app subnet 1367(1)-(N) that can be contained in respective container egress VCNs 1368(1)-(N) that can be contained in respective customer tenancies 1370(1)-(N). Respective secondary VNICs 1372(1)-(N) can facilitate communication between the untrusted app subnet(s) 1362 contained in the data plane VCN 1318 and the app subnet contained in the container egress VCNs 1368(1)-(N). Each container egress VCNs 1368(1)-(N) can include a NAT gateway 1338 that can be communicatively coupled to public Internet 1354 (e.g. public Internet 1154).

The Internet gateway 1334 contained in the control plane VCN 1316 and contained in the data plane VCN 1318 can be communicatively coupled to a metadata management service 1352 (e.g., the metadata management system 1152) that can be communicatively coupled to public Internet 1354. Public Internet 1354 can be communicatively coupled to the NAT gateway 1338 contained in the control plane VCN 1316 and contained in the data plane VCN 1318. The service gateway 1336 contained in the control plane VCN 1316 and contained in the data plane VCN 1318 can be communicatively couple to cloud services 1356.

In some embodiments, the data plane VCN 1318 can be integrated with customer tenancies 1370. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane tier app 1346. Code to run the function may be executed in the VMs 1366(1)-(N), and the code may not be configured to run anywhere else on the data plane VCN 1318. Each VM 1366(1)-(N) may be connected to one customer tenancy 1370. Respective containers 1371(1)-(N) contained in the VMs 1366(1)-(N) may be configured to run the code. In this case, there can be a dual isolation (e.g., the containers 1371(1)-(N) running code, where the containers 1371(1)-(N) may be contained in at least the VM 1366(1)-(N) that are contained in the untrusted app subnet(s) 1362), which may help prevent incorrect or otherwise undesirable code from damaging the network of the IaaS provider or from damaging a network of a different customer. The containers 1371(1)-(N) may be communicatively coupled to the customer tenancy 1370 and may be configured to transmit or receive data from the customer tenancy 1370. The containers 1371(1)-(N) may not be configured to transmit or receive data from any other entity in the data plane VCN 1318. Upon completion of running the code, the IaaS provider may kill or otherwise dispose of the containers 1371(1)-(N).

In some embodiments, the trusted app subnet(s) 1360 may run code that may be owned or operated by the IaaS provider. In this embodiment, the trusted app subnet(s) 1360 may be communicatively coupled to the DB subnet(s) 1330 and be configured to execute CRUD operations in the DB subnet(s) 1330. The untrusted app subnet(s) 1362 may be communicatively coupled to the DB subnet(s) 1330, but in this embodiment, the untrusted app subnet(s) may be configured to execute read operations in the DB subnet(s) 1330. The containers 1371(1)-(N) that can be contained in the VM 1366(1)-(N) of each customer and that may run code from the customer may not be communicatively coupled with the DB subnet(s) 1330.

In other embodiments, the control plane VCN 1316 and the data plane VCN 1318 may not be directly communicatively coupled. In this embodiment, there may be no direct communication between the control plane VCN 1316 and the data plane VCN 1318. However, communication can occur indirectly through at least one method. An LPG 1310 may be established by the IaaS provider that can facilitate communication between the control plane VCN 1316 and the data plane VCN 1318. In another example, the control plane VCN 1316 or the data plane VCN 1318 can make a call to cloud services 1356 via the service gateway 1336. For example, a call to cloud services 1356 from the control plane VCN 1316 can include a request for a service that can communicate with the data plane VCN 1318.

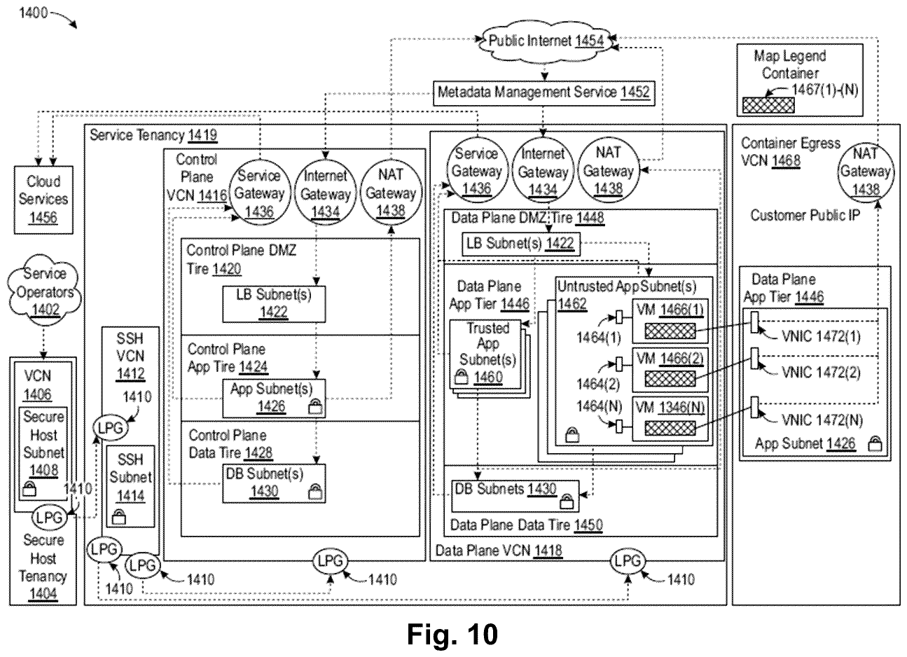

FIG. 10 is a block diagram 1400 illustrating another example pattern of an IaaS architecture, according to at least one embodiment. Service operators 1402 (e.g. service operators 1102) can be communicatively coupled to a secure host tenancy 1404 (e.g. the secure host tenancy 1104) that can include a virtual cloud network (“VCN”) 1406 (e.g. the VCN 1106) and a secure host subnet 1408 (e.g. the secure host subnet 1108). The VCN 1406 can include an LPG 1410 (e.g. the LPG 1110) that can be communicatively coupled to an SSH VCN 1412 (e.g. the SSH VCN 1112) via an LPG 1410 contained in the SSH VCN 1412. The SSH VCN 1412 can include an SSH subnet 1414 (e.g. the SSH subnet 1114), and the SSH VCN 1412 can be communicatively coupled to a control plane VCN 1416 (e.g. the control plane VCN 1116) via an LPG 1410 contained in the control plane VCN 1416 and to a data plane VCN 1418 (e.g. the data plane 1118) via an LPG 1410 contained in the data plane VCN 1418. The control plane VCN 1416 and the data plane VCN 1418 can be contained in a service tenancy 1419 (e.g. the service tenancy 1119).

The control plane VCN 1416 can include a control plane DMZ tier 1420 (e.g. the control plane DMZ tier 1120) that can include LB subnet(s) 1422 (e.g. LB subnet(s) 1122), a control plane app tier 1424 (e.g. the control plane app tier 1124) that can include app subnet(s) 1426 (e.g. app subnet(s) 1126), a control plane data tier 1428 (e.g. the control plane data tier 1128) that can include DB subnet(s) 1430 (e.g. DB subnet(s) 1330). The LB subnet(s) 1422 contained in the control plane DMZ tier 1420 can be communicatively coupled to the app subnet(s) 1426 contained in the control plane app tier 1424 and to an Internet gateway 1434 (e.g. the Internet gateway 1134) that can be contained in the control plane VCN 1416, and the app subnet(s) 1426 can be communicatively coupled to the DB subnet(s) 1430 contained in the control plane data tier 1428 and to a service gateway 1436 (e.g. the service gateway 1136) and a network address translation (NAT) gateway 1438 (e.g. the NAT gateway 1138). The control plane VCN 1416 can include the service gateway 1436 and the NAT gateway 1438.

The data plane VCN 1418 can include a data plane app tier 1446 (e.g. the data plane app tier 1146), a data plane DMZ tier 1448 (e.g. the data plane DMZ tier 1148), and a data plane data tier 1450 (e.g. the data plane data tier 1150). The data plane DMZ tier 1448 can include LB subnet(s) 1422 that can be communicatively coupled to trusted app subnet(s) 1460 (e.g. trusted app subnet(s) 1360) and untrusted app subnet(s) 1462 (e.g. untrusted app subnet(s) 1362) of the data plane app tier 1446 and the Internet gateway 1434 contained in the data plane VCN 1418. The trusted app subnet(s) 1460 can be communicatively coupled to the service gateway 1436 contained in the data plane VCN 1418, the NAT gateway 1438 contained in the data plane VCN 1418, and DB subnet(s) 1430 contained in the data plane data tier 1450. The untrusted app subnet(s) 1462 can be communicatively coupled to the service gateway 1436 contained in the data plane VCN 1418 and DB subnet(s) 1430 contained in the data plane data tier 1450. The data plane data tier 1450 can include DB subnet(s) 1430 that can be communicatively coupled to the service gateway 1436 contained in the data plane VCN 1418.

The untrusted app subnet(s) 1462 can include primary VNICs 1464(1)-(N) that can be communicatively coupled to tenant virtual machines (VMs) 1466(1)-(N) residing within the untrusted app subnet(s) 1462. Each tenant VM 1466(1)-(N) can run code in a respective container 1467(1)-(N), and be communicatively coupled to an app subnet 1426 that can be contained in a data plane app tier 1446 that can be contained in a container egress VCN 1468. Respective secondary VNICs 1472(1)-(N) can facilitate communication between the untrusted app subnet(s) 1462 contained in the data plane VCN 1418 and the app subnet contained in the container egress VCN 1468. The container egress VCN can include a NAT gateway 1438 that can be communicatively coupled to public Internet 1454 (e.g. public Internet 1154).

The Internet gateway 1434 contained in the control plane VCN 1416 and contained in the data plane VCN 1418 can be communicatively coupled to a metadata management service 1452 (e.g. the metadata management system 1152) that can be communicatively coupled to public Internet 1454. Public Internet 1454 can be communicatively coupled to the NAT gateway 1438 contained in the control plane VCN 1416 and contained in the data plane VCN 1418. The service gateway 1436 contained in the control plane VCN 1416 and contained in the data plane VCN 1418 can be communicatively couple to cloud services 1456.

In some examples, the pattern illustrated by the architecture of block diagram 1400 of FIG. 10 may be considered an exception to the pattern illustrated by the architecture of block diagram 1300 of FIG. 9 and may be desirable for a customer of the IaaS provider if the IaaS provider cannot directly communicate with the customer (e.g., a disconnected region). The respective containers 1467(1)-(N) that are contained in the VMs 1466(1)-(N) for each customer can be accessed in real-time by the customer. The containers 1467(1)-(N) may be configured to make calls to respective secondary VNICs 1472(1)-(N) contained in app subnet(s) 1426 of the data plane app tier 1446 that can be contained in the container egress VCN 1468. The secondary VNICs 1472(1)-(N) can transmit the calls to the NAT gateway 1438 that may transmit the calls to public Internet 1454. In this example, the containers 1467(1)-(N) that can be accessed in real-time by the customer can be isolated from the control plane VCN 1416 and can be isolated from other entities contained in the data plane VCN 1418. The containers 1467(1)-(N) may also be isolated from resources from other customers.

In other examples, the customer can use the containers 1467(1)-(N) to call cloud services 1456. In this example, the customer may run code in the containers 1467(1)-(N) that requests a service from cloud services 1456. The containers 1467(1)-(N) can transmit this request to the secondary VNICs 1472(1)-(N) that can transmit the request to the NAT gateway that can transmit the request to public Internet 1454. Public Internet 1454 can transmit the request to LB subnet(s) 1422 contained in the control plane VCN 1416 via the Internet gateway 1434. In response to determining the request is valid, the LB subnet(s) can transmit the request to app subnet(s) 1426 that can transmit the request to cloud services 1456 via the service gateway 1436.

It should be appreciated that IaaS architectures 1100, 1200, 1300, 1400 depicted in the figures may have other components than those depicted. Further, the embodiments shown in the figures are only some examples of a cloud infrastructure system that may incorporate certain embodiments. In some other embodiments, the IaaS systems may have more or fewer components than shown in the figures, may combine two or more components, or may have a different configuration or arrangement of components.

As disclosed, embodiments solves the problem of setting optimal booking limits for the hotel reservations made in the basic room category. It is assumed that when the premium room category is expected to be booked below capacity, the overbooking of the basic room category can use extra space in the premium category. In addition, the hotel may offer the basic room category customers an upgrade to the premium rooms at a discount rate.

Therefore, embodiments consider two sets of decision variables, daily overbooking limits for the basic category and upgrade offer prices, with the objective to optimize the total revenue subject to overall room capacity. By setting the overbooking limits, embodiments result in the optimal tradeoff between selling some premium rooms at the basic room rate and keeping other premium rooms aside for the potential future sales at premium rate, which is also known as fare protection. Further, embodiments solve the problem in a more general multi-day setting by deciding on every multi-day reservation whether to allow its booking based on the current booking level, thus exercising so-called admission control. Further, embodiments adjust the booking limits by accounting for the predicted booking cancellations.

In general, embodiments calculate the marginal revenue, that is, the additional revenue generated from increasing the booking limit by one room. The marginal revenue is calculated as the difference between basic room rate and expected future sales of premium room. The latter is determined as the product of probability to reach the respective level of demand for premium rooms and premium room rate. Since the marginal revenue is diminishing as the function of the booking limit and eventually becomes negative, the revenue function is concave and the optimal solution is reached at the point of zero marginal revenue. When the paid upgrade is offered, the optimal upgrade price is calculated as the so-called Stock Clearing Price (“SCP”), where the price is set as the maximum of revenue maximizing price and the price of selling all overbooked premium rooms to some of the basic room customers based on the demand model estimated from the historic data. Then the marginal revenue generated from upgrade offers is added to the revenue generated from selling basic rooms. The decision to admit a multi-day reservation is based on computing the difference of the total reservation rate and the total of expected marginal premium room bookings adjusted for the SCP-based paid upgrade offer revenue. Finally, embodiments account for the cancellation of the basic rooms bookings by constructing the probability distribution for the sum of two random variables, the number of the premium room bookings and the number of basic room cancellations, which are derived from the historic sales observations.

Embodiments implement a novel mechanism that efficiently computes a marginal rate of return per extra overbooked room based on the demand model derived from the observation of the previous sales. Further, embodiments incorporate the dynamic price optimization for the paid upgrade offers, which is used jointly with the booking limit decision to obtain an optimal solution. Further, the approach is generalized to be applicable in the case of multiday bookings. Finally, the approach accounts for the future potential cancellations of the basic room bookings, which allows to increase the booking limits.

The features, structures, or characteristics of the disclosure described throughout this specification may be combined in any suitable manner in one or more embodiments. For example, the usage of “one embodiment,” “some embodiments,” “certain embodiment,” “certain embodiments,” or other similar language, throughout this specification refers to the fact that a particular feature, structure, or characteristic described in connection with the embodiment may be included in at least one embodiment of the present disclosure. Thus, appearances of the phrases “one embodiment,” “some embodiments,” “a certain embodiment,” “certain embodiments,” or other similar language, throughout this specification do not necessarily all refer to the same group of embodiments, and the described features, structures, or characteristics may be combined in any suitable manner in one or more embodiments.

One having ordinary skill in the art will readily understand that the embodiments as discussed above may be practiced with steps in a different order, and/or with elements in configurations that are different than those which are disclosed. Therefore, although this disclosure considers the outlined embodiments, it would be apparent to those of skill in the art that certain modifications, variations, and alternative constructions would be apparent, while remaining within the spirit and scope of this disclosure. In order to determine the metes and bounds of the disclosure, therefore, reference should be made to the appended claims.

What is claimed is:

1. A method of optimizing hotel room overbooking limits for reservations of hotel rooms of a hotel, the method comprising:
receiving historical reservation data;
determining an upgrade offer acceptance probability as a function offer price based on the historical reservation data;
determining a premium category occupancy distribution based on the historical reservation data;
determining a basic category cancellation distribution based on the historical reservation data;
determining an optimal upgrade price as a function of overbooked rooms from the upgrade offer acceptance probability;
determining a marginal revenue as a function of overbooked rooms based on the determined premium category occupancy distribution and the determined optimal upgrade price as a function of overbooked rooms; and
determining a marginal loss as a function of overbooked rooms from the basic category cancellation distribution.

2. The method of claim 1, further comprising:
determining the optimal overbooking limit on a per room category basis from the determined marginal revenue as a function of overbooked rooms and the determined marginal loss as a function of overbooked rooms.

3. The method of claim 1, the historical reservation data comprising:
upgrade offer acceptance historical data;
premium category booking data; and
basic category booking data.

4. The method of claim 2, wherein the determining the optimal overbooking limit on a per room category basis is in response to a multi-day reservation.

5. The method of claim 2, wherein the determining an optimal upgrade price comprises a generating a linear demand model and generating a log-linear demand model.

6. The method claim 2, further comprising:
based on the overbooking limit, accepting additional reservations for each of the categories up to the overbooking limits; and
in response to the additional reservations, automatically encoding corresponding hotel room keys.

7. The method of claim 1, further comprising determining a marginal cost of premium capacity.

8. The method of claim 7, the determining the marginal cost comprising:
generating a random demand sample;
solving an admission control as a Linear Programming problem;
obtaining a dual costs of constraints; and
repeating and obtaining an average cost of constraints.

9. A computer readable medium having instructions stored thereon that, when executed by one or more processors, cause the processors to optimize hotel room overbooking limits for reservations of hotel rooms of a hotel, the optimizing comprising:
receiving historical reservation data;
determining an upgrade offer acceptance probability as a function offer price based on the historical reservation data;
determining a premium category occupancy distribution based on the historical reservation data;
determining a basic category cancellation distribution based on the historical reservation data;
determining an optimal upgrade price as a function of overbooked rooms from the upgrade offer acceptance probability;
determining a marginal revenue as a function of overbooked rooms based on the determined premium category occupancy distribution and the determined optimal upgrade price as a function of overbooked rooms; and
determining a marginal loss as a function of overbooked rooms from the basic category cancellation distribution.

10. The computer readable medium of claim 9, the optimizing further comprising:
determining the optimal overbooking limit on a per room category basis from the determined marginal revenue as a function of overbooked rooms and the determined marginal loss as a function of overbooked rooms.

11. The computer readable medium of claim 9, the historical reservation data comprising:
upgrade offer acceptance historical data;
premium category booking data; and
basic category booking data.

12. The computer readable medium of claim 10, wherein the determining the optimal overbooking limit on a per room category basis is in response to a multi-day reservation.

13. The computer readable medium of claim 10, wherein the determining an optimal upgrade price comprises a generating a linear demand model and generating a log-linear demand model.

14. The computer readable medium of claim 10, the optimizing further comprising:
based on the overbooking limit, accepting additional reservations for each of the categories up to the overbooking limits; and
in response to the additional reservations, automatically encoding corresponding hotel room keys.

15. The computer readable medium of claim 9, the optimizing further comprising determining a marginal cost of premium capacity.

16. The computer readable medium of claim 15, the determining the marginal cost comprising:
generating a random demand sample;
solving an admission control as a Linear Programming problem;
obtaining a dual costs of constraints; and
repeating and obtaining an average cost of constraints.

17. A cloud based hotel reservation system that optimizes hotel room overbooking limits for reservations of hotel rooms of a hotel, the system comprising:
one or more processors adapted to:
receive historical reservation data;
determine an upgrade offer acceptance probability as a function offer price based on the historical reservation data;
determine a premium category occupancy distribution based on the historical reservation data;
determine a basic category cancellation distribution based on the historical reservation data;
determine an optimal upgrade price as a function of overbooked rooms from the upgrade offer acceptance probability;
determine a marginal revenue as a function of overbooked rooms based on the determined premium category occupancy distribution and the determined optimal upgrade price as a function of overbooked rooms; and
determine a marginal loss as a function of overbooked rooms from the basic category cancellation distribution.

18. The system of claim 17, the one or more processors further adapted to:
determine the optimal overbooking limit on a per room category basis from the determined marginal revenue as a function of overbooked rooms and the determined marginal loss as a function of overbooked rooms.

19. The system of claim 17, the historical reservation data comprising:
upgrade offer acceptance historical data;
premium category booking data; and
basic category booking data.

20. The system of claim 18, wherein the determine the optimal overbooking limit on a per room category basis is in response to a multi-day reservation.
